(19) United States
(12) Patent Application Publication
(10) Pub. No.: US 2025/0173258 A1
(43) Pub. Date: May 29, 2025

(54) A Concept for Providing Access to Persistent Memory

(71) Applicant: Intel Corporation, Santa Clara, CA (US)

(72) Inventors: Ziye YANG, Shanghai (CN); Paul LUSE, Chandler, AZ (US); James HARRIS, Chandler, AZ (US); Benjamin WALKER, Chandler, AZ (US)

(21) Appl. No.: 18/842,824

(22) PCT Filed: Mar. 31, 2022
(86) PCT No.: PCT/CN2022/084363

§ 371 Date: Aug. 30, 2024

(51) Int. Cl. G06F 12/02

(52) U.S. Cl. CPC G06F 12/023

(57) ABSTRACT

Examples relate to an apparatus, a device, a method, and a computer program for a computer system, and to a corresponding computer system. The apparatus comprises circuitry config-ured to provide an interface for accessing persistent memory provided by persistent memory circuitry of the computer system from one or more software applications. The circuitry is configured to translate instructions for performing operations on the persistent memory into corresponding instructions for offloading circuitry of the computer system, the corresponding instructions being suitable for instructing the offloading circuitry to perform the operations on the persistent memory. The circuitry is configured to provide the access to the persistent memory via the offloading circuitry.

### BACKGROUND

With the growing usage of persistent memory (short PMEM) in data centers, operations being performed on the persistent memory may increase the burden on the CPU (Central Processing Unit) resources. For example, in HCI (hyper converged infrastructures), cloud providers use vhost (virtual host) block solutions to drive many SSDs (Solid-State Drives) to serve the I/O (Input/Output) needs of different virtual machines. Because of the DMA (Direct Memory Access) feature of the underlying devices, the CPU is generally not a bottleneck for accessing the SSDs, and the QoS (Quality of Service) of each VM's (Virtual Machine's) I/O can easily be guaranteed. Upon receiving an I/O from the virtual machine, the vhost target can issue an I/O request via the drivers and CPU can switch to serve other VMs and complete the I/O of each VM later. But when equipped with a PMEM device, this can be broken, as, for every VM's I/O on the PMEM, a CPU may be blocked to serve it, with no interruption possible. So, it may become a challenge to guarantee the QoS for serving many VMs, with no DMA feature being available for using PMEM (in application direct mode).

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for a computer system, and of the computer system comprising the apparatus or device;

FIGS. 1b and 1c show flow charts of examples of a method for a computer system;

FIG. 2 shows a schematic diagram of a use of an acceleration framework;

FIGS. 3a and 3b show flow charts of a usage of a proposed acceleration framework; and

FIG. 4 shows a performance comparison of different combinations of CPU, offloading device and persistent memory device.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

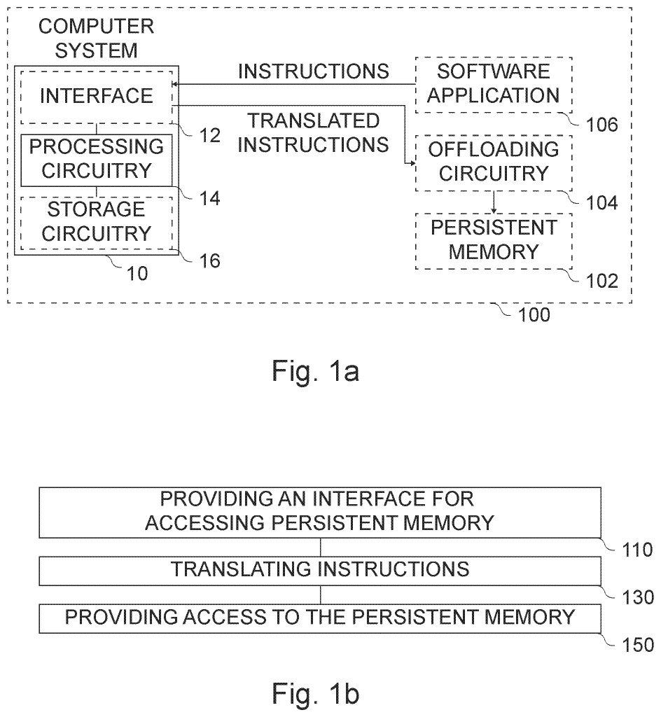

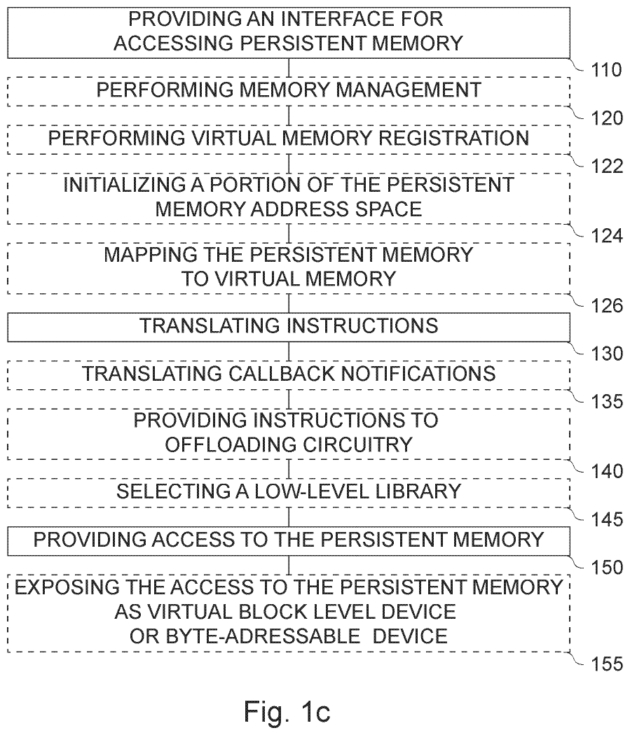

FIG. 1a shows a block diagram of an example of an apparatus 10 or device 10 for a computer system 100. The apparatus 10 comprises circuitry that is configured to provide the functionality of the apparatus 10. For example, the apparatus 10 of FIGS. 1a and 1b comprises (optional) interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., with other components of the computer system, such as persistent memory circuitry/a persistent memory device 102, offloading circuitry/means for offloading 104 and/or one or more applications 106) and the storage circuitry 16 (for storing information). Likewise, the device 10 may comprise means that is/are configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, (optional) means for communicating 12, which may correspond to or be implemented by the interface circuitry 12, and (optional) means for storing information 16, which may correspond to or be implemented by the storage circuitry 16.

FIG. 1a further shows the computer system 100 comprising the apparatus 10 or device 10, the persistent memory circuitry or persistent memory device 102 and the offloading circuitry or means for offloading 104. The computer system 100 is configured to execute the one or more applications 106. In particular, the processing circuitry or means for processing 14 may be configured to execute the one or more applications 106.

The circuitry (e.g., the processing circuitry 14) or means (e.g., the means for processing 14) is configured to provide an interface for accessing persistent memory provided by the persistent memory circuitry 102 of the computer system from the one or more software applications 106. The circuitry (e.g., the processing circuitry 14) or means (e.g., the means for processing 14) is configured to translate instructions for performing operations on the persistent memory into corresponding instructions for offloading circuitry 104 of the computer system. The corresponding instructions are suitable for instructing the offloading circuitry to perform the operations on the persistent memory. The circuitry (e.g., the processing circuitry 14) or means (e.g., the means for processing 14) is configured to provide the access to the persistent memory via the offloading circuitry.

FIGS. 1b and 1c show flow charts of examples of a corresponding method for the computer system 100. For example, the method may be performed by the computer system 100, e.g., by the (processing) circuitry or means (for processing) of the computer system 100. The method comprises providing 110 the interface for accessing persistent memory provided by the persistent memory circuitry 102 of the computer system from the one or more software applications. The method comprises translating 130 the instructions for performing operations on the persistent memory into the corresponding instructions for offloading circuitry 104 of the computer system, with the corresponding instructions being suitable for instructing the offloading circuitry to perform the operations on the persistent memory. The method comprises providing 150 the access to the persistent memory via the offloading circuitry.

In the following, the functionality of the computer system 100, the apparatus 10, the device 10, the method and of a corresponding computer program is introduced in connection with the computer system 100 and the apparatus 10. Features introduced in connection with the computer system 100 and apparatus 10 may likewise be included in the corresponding device 10, method and computer program.

Various examples of the present disclosure relate to an apparatus, device, method, and computer program that can be used to provide access to persistent memory for one or more software applications. In the present disclosure, an interface is provided to provide the access to the offloading circuitry. It is a “common” interface, as it provides the access to the persistent circuitry independent or regardless of the offloading circuitry being used for accessing the persistent memory. Moreover, the instructions (i.e., requests) being used to access the common from the one or more software applications may be the same regardless of which offloading circuitry is being used. The interface provides a layer of abstraction between the one or more software applications and the offloading circuitry. For example, the interface may be implemented as an application programming interface (API) and/or as a software library that can be accessed by the one or more software applications. In particular, the proposed interface, and the (translation) functionality contained therein, may be provided as a (lightweight) framework. In other words, the circuitry may be configured to provide the interface and/or translate the instructions by providing a software framework for accessing the persistent memory. In general, the interface may be provided (and accessed) in user-space or in kernel-space. The one or more software applications may communicate with the common interface in user space, and the common interface may access the low-level driver of the offloading circuitry to communicate with the offloading circuitry. For example, the circuitry may be configured to provide the corresponding instructions (i.e., the translated instructions) to the offloading circuitry via a low-level library (e.g., driver) of the offloading circuitry. Accordingly, the method may comprise providing 140 the corresponding instructions to the offloading circuitry via a low-level library of the offloading circuitry.

In some examples, different types of offloading devices are supported by the apparatus. For example, the circuitry may be configured to select, depending on which offloading circuitry is available in the computer system, a corresponding low-level library for accessing the offloading circuitry. Accordingly, as further shown in FIG. 1c, the method may comprise selecting, depending on which offloading circuitry is available in the computer system, a corresponding low-level library for accessing the offloading circuitry. This is particularly useful in scenarios, where multiple pieces of offloading circuitry are comprised by the computer system. For example, the circuitry may be configured to provide access to the persistent memory via first offloading circuitry and via second offloading circuitry, and to select the low-level library of the first or second offloading circuitry depending on which of the first and second offloading circuitry is used for accessing the persistent memory. Accordingly, as further shown in FIG. 1c, the method may comprise providing 150 access to the persistent memory via first offloading circuitry and via second offloading circuitry and selecting 145 the low-level library of the first or second offloading circuitry depending on which of the first and second offloading circuitry is used for accessing the persistent memory.

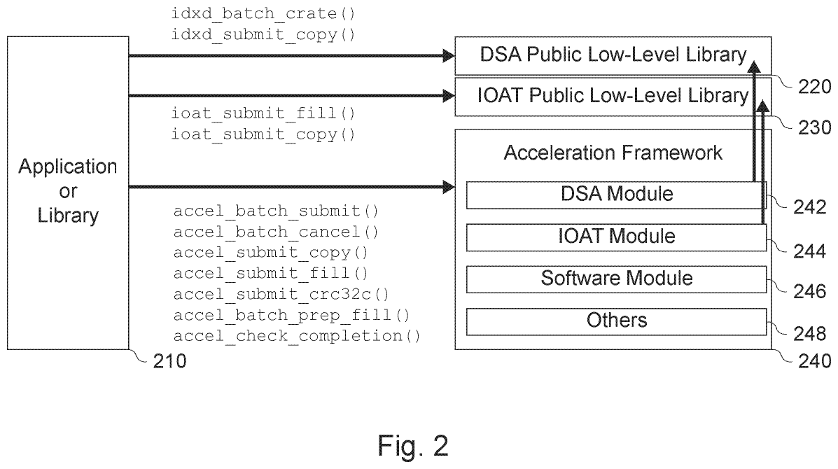

The proposed concept is used to provide access to persistent memory. In connection with FIGS. 2 to 4, an example is provided of a Data Streaming Accelerator (DSA) and an Input/Output Acceleration Technology (IOAT) device, which is are examples of data access offloading circuitry, i.e., circuitry that is used to offload processing related to the accessing of data. However, the proposed concept is not limited to such data access offloading circuitry but may support any kind of offloading circuitry. For example, the offloading circuitry may be one of computation offloading circuitry (such as an accelerator card or a coprocessor) and data access offloading circuitry. In more general terms, the offloading circuitry may be circuitry for offloading an aspect of data processing from a general-purpose processing portion of a Central Processing Unit (CPU) of a computer system. For example, the offloading circuitry may be included in a CPU of the computer system, e.g., in addition to the general-purpose processing portion of the CPU. For example, the CPU of the computer system may correspond to the processing circuitry 14. The persistent memory circuitry may be memory circuitry that enables a persistent storage of the information held in the memory. For example, the persistent memory circuitry may use three-dimensional cross-point memory, such as Intel® 3D XPoint™-based persistent memory. For example, the persistent memory circuitry may be implemented as a Dual In-line Memory Module.

For example, the interface may be used by any application being executed on the computer system. For example, the one or more software applications may be executed using the processing circuitry, interface circuitry and/or storage circuitry of the apparatus 10. The interface may be particularly useful for software applications that themselves provide a layer of abstraction, such as software containers or virtual machines. In other words, the one or more software applications may comprise at least one of a software container and a virtual machine. For such types of software applications, the access of the persistent memory may be provided as virtual block-level device or byte-level addressable device, to enable usage of the interface without having to adapt the software application. In other words, the circuitry may be configured to expose the access to the persistent memory as a virtual block-level device or a byte-addressable device. Accordingly, as further shown in FIG. 1c, the method may comprise exposing 155 the access to the persistent memory as a virtual block-level device or a byte-addressable device. For example, the virtual block-level device or byte-addressable device may be exposed by the interface. For example, under the Linux operating system, Direct Access (DAX) may be used to mount the virtual block-level device or byte-addressable device, with the interface providing the functionality behind the virtual block-level device or byte-addressable device.

Before the persistent device is used by an application, access to the persistent memory may be set up. For example, a virtual memory mechanism may be set up for accessing the persistent. For example, for each application (or block device/byte-addressable device), a separate virtual memory address space may be set up. The circuitry may be configured to perform memory management (e.g., implement a memory management unit, similar to IOMMU, Input/Output Memory Management Unit)) for accessing the persistent memory. Accordingly, as further shown in FIG. 1c, the method may comprise performing 120 memory management for accessing the persistent memory. In general, such a memory management unit is used to map virtual memory addresses to the “real” memory addresses of the respective devices. For example, the circuitry may be configured to perform virtual memory registration, by setting up the virtual memory addresses and mapping the virtual memory addresses to addresses of the persistent memory address space. Accordingly, as further shown in FIG. 1c, the method may comprise performing 122 virtual memory registration, by setting up the virtual memory addresses and mapping 126 the virtual memory addresses to addresses of the persistent memory address space. In other words, a mapping between the virtual memory addresses and the addresses in the persistent memory address space may be used to access the memory. The circuitry may be configured to provide access to the persistent memory via a memory mapping technique, with the memory management mapping the persistent memory address space to virtual memory addresses. Accordingly, access to the persistent memory may be provided 150 via a memory mapping technique, with the memory management mapping 126 the persistent memory address space to virtual memory addresses. For example, huge pages, and in particular pinned huge pages, may be used.

As outlined above, the one or more applications may be executed in user-space. To make sure these applications can consistently access the persistent memory, various examples of the present disclosure use a pinned pages mechanism for the mapping. Pinning pages is a mechanism that makes sure that the respective pages are exempt from paging. The circuitry may be configured to map the persistent memory to the virtual memory addresses using a pinned page mechanism. Accordingly, the method may comprise mapping 126 the persistent memory to the virtual memory addresses using a pinned page mechanism. Thus, the persistent memory addresses can be mapped to the process without changing at runtime, making it accessible to the offloading circuitry at any time.

In general, persistent memory can be formatted with different block sizes, alignment values etc. In general, the offloading circuitry may access the persistent memory according to the alignment. For example, the circuitry may be configured to initialize a portion of the persistent memory address space with an alignment of memory addresses that matches the offloading circuitry access alignment requirements. Accordingly, as further shown in FIG. 1c, the method may comprise initializing 124 a portion of the persistent memory address space with an alignment of memory addresses that matches the offloading circuitry access alignment requirements. For example, an alignment may be used that matches the page size (or a multiple therefor) of the (huge) pages used by the memory management. For example, alignment of memory addresses may be based on multiples of the corresponding memory page sizes. If the address is not aligned, some conversions may be performed, or the access request may be split.

In the proposed concept, the interface hides the involvement of the offloading circuitry while accessing the persistent memory behind the abstraction layer provided by the interface. To make the interface work, the instructions obtained via the interface are translated into corresponding instructions that involve the offloading circuitry. For example, generic instructions (or even implicit instructions, if the instructions are obtained via the virtual block-level or byte-accessible device) may be translated into instructions for the offloading circuitry, to cause the offloading circuitry to perform the instruction. In other words, the instructions for performing operations on the persistent memory may be translated into corresponding instructions (i.e., translated instructions) for offloading circuitry 104 of the computer system, to trigger the offloading circuitry to perform the operations on the persistent memory. To improve the efficiency and throughput (e.g., in terms of I/O operations per second, IOPS, or in terms of data rate), access via the interface may be provided asynchronously. For example, the circuitry may be configured to provide the access to the persistent memory via asynchronous interface calls. Accordingly, the access to the persistent memory may be provided 150 via asynchronous interface calls. For example, an application (or rather the CPU executing code of the application) may issue an instruction to the interface. Instead of letting the CPU wait (e.g., using busy waiting) until the operation contained in the instruction is completed, the instruction may be issued asynchronously. If this is the case, the application will receive a callback from the interface once the operation is completed. In the meantime, the CPU may perform other tasks. For example, the instructions for performing operations may be asynchronous instructions, i.e., instructions that do not cause the CPU to wait for the result. They may be translated into corresponding asynchronous instructions for the offloading circuitry. For example, the circuitry may be configured to translate the instructions for performing operations on the persistent memory into corresponding asynchronous instructions for the offloading circuitry. Accordingly, the instructions for performing operations on the persistent memory may be translated 130 into corresponding asynchronous instructions for the offloading circuitry.

The interface may be configured to notify (e.g., using a callback notification) the one or more applications once an operation triggered by an instruction is complete. For this, either polling may be used (e.g., the interface/circuitry may periodically check whether the operation was completed by the offloading circuitry), or a callback issued by the offloading circuitry may be translated and provided to the respective application. For example, the circuitry may be configured to poll the offloading circuitry (periodically), and to issue a callback notification to the respective application once the operation is completed. Accordingly, the method may comprise polling the offloading circuitry, and issuing a callback notification to the respective application once the operation is completed. Alternatively, the circuitry may be configured to translate callback notifications issued by the offloading circuitry into callback notifications for the one or more software applications. Accordingly, the method may comprise translating 135 callback notifications issued by the offloading circuitry into callback notifications for the one or more software applications.

In various examples of the present disclosure, it may be undesirable to involve the cache of the CPU of the computer system, e.g., to avoid situations in which changes are only applied to the CPU cache but are not written to the persistent memory. In case of a sudden loss of power, such data might be lost. For example, the circuitry may be configured to provide the interface such, that the data written to the persistent memory bypasses the CPU cache. Accordingly, the method may comprise providing the interface such, that the data written to the persistent memory bypasses the CPU cache.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus, device, method, computer program and computer system are mentioned in connection with the proposed concept, or one or more examples described above or below (e.g., FIGS. 2 to 4). The apparatus, device, method, computer program and computer system may comprise one or more additional optional features corresponding to one or more aspects of the proposed concept, or one or more examples described above or below.

Various examples of the present disclosure relate to a method and apparatus for accelerating persistent memory access and/or ensuring the data integrity via a hardware-based memory offloading technique.

To support access to persistent memory in a computer system, some hardware-based memory offloading engines may be leveraged to move the data between DRAM (Dynamic Random memory access) and persistent memory. For example, offloading engines such as the Intel® Data Streaming Accelerator (DSA) or Intel® I/O Acceleration Technology (IOAT, formerly known as QuickData) to reduce the CPU utilization.

However, the access via such offloading engines may be cumbersome. In particular, there might be no suitable framework for integrating hardware-based memory offloading engines (e.g., IOAT/DSA) together for accessing the persistent memory. Though libraries such as Intel's Data Mover Library (DML) or the oneAPI (One Application Programming Interface) library exist, those libraries may be considered to be heavyweight and cannot be easily to be adapted into low level storage integration (e.g., on block level) with fine-grained control, e.g., queue depth control on the WQs (Working Queues) on the DSA device. Furthermore, data persistency issue using memory offloading devices (e.g., IOAT/DSA) may still be addressed. In addition, the use of an offloading engine, such as IOAT or DSA, to access PMEM devices, may be unexplored.

In addition, there may be limitations in PMEM related software. While the PMDK (Persistent Memory Development Kit) library provided to access the persistent memory (e.g., Intel® Optane™) via CPU. However, this library is developed for CPU usage mode, without an asynchronous interface designed to access the persistent memory, and without a plugin system to offload the persistent memory access via an offloading device, such as IOAT or DSA. As a result, offloading engines (such as IOAT/DSA) cannot be directly leveraged while using the PMDK library. Additionally, other libraries such libpmem_accel, libpmemblk can be leveraged to access PMEM devices, but they currently still provide a synchronous interface.

Various examples of the proposed concept address the above challenges. The proposed concept may provide a lightweight framework (relative to oneAPI, for example) to leverage both offloading devices, such as Intel® IOAT or DSA to access the persistent memory. Meanwhile, the proposed framework may be flexible and can support different platforms on different PMEM generation products and different memory offloading devices. In an example implementation, IOAT/DSA were used to accelerate access to the persistent memory. Compared with a CPU-bound approach, at least 1.5 times performance improvement was realized in the example implementation, while mitigating the challenge of CPU pressure caused by operating PMEM devices. For example, the performance improvement may leverage the capability of IOAT/DSA devices under the acceleration framework, as the devices take over the copy job between memory and PMEM device and thus reduce the CPU burden. In effect, the CPU may perform more read/write I/O requests to the PMEM device. Additionally, this performance may be achieved through the use of asynchronous API provided by the proposed acceleration framework, so the CPU does not need to wait for the response from the underly device directly, which may also save CPU resources.

Some examples of the proposed concept further consider the case of unexpected power loss cases while using offloading devices, such as IOAT or DSA. In the present concept, the offloading device(s) may conduct the data operations between DRAM (Dynamic RAM) and persistent memory. Furthermore, data persistency (e.g., data is in CPU cache/memory (e.g., page cache)->PMEM) while power is lost may be addressed. To mitigate unexpected power down situations, at least some examples try to bypass the CPU cache.

Various examples of the present disclosure provide a lightweight framework (which may be provided by the apparatus, device, method and/or computer program introduced in connection with FIGS. 1a to 1c) that can be used to drive the hardware-based memory offloading (e.g., IOAT/DSA) in one software stack for storage application usage on PMEM devices. Moreover, this framework may be utilized to with other memory offloading devices as well. A design is presented on how to use this framework to design and implement a high-performance block device service constructed on PMEM devices, providing high performance. The data movement between DRAM and PMEM device can be offloaded through this acceleration framework by the underlying DSA. For other operations, such as CRC32c (a Cyclic Redundancy Check algorithm) or DIF (Data Integrity Field) calculation offloading, which are similar.

Based on this acceleration framework, users can use offloading devices in a unified software stack. In particular with respect to storage scope, the CPU utilization on PMEM devices may be reduced via the proposed acceleration framework. For example, in HCI (hyper converged infrastructures), cloud providers use vhost (virtual host) block solutions to drive many SSDs (Solid-State Drives) to serve the I/O (Input/Output) needs of different virtual machines. Because of the DMA (Direct Memory Access) feature of the underlying devices, the CPU is generally not be a bottleneck for accessing the SSDs, and the QoS (Quality of Service) of each VM's (Virtual Machine's) I/O can easily be guaranteed. Upon receiving the I/O from the virtual machine, the vhost target can issue an I/O request via the drivers and CPU can switch to serve other VMs and complete the I/O of each VM later. But when equipped with a PMEM device, this can be broken, as, for every VM's I/O on the PMEM, a CPU may be blocked to serve it, with no interruption possible. This may be mitigated by the proposed concept.

FIG. 2 shows an example of a lightweight unified acceleration framework which can leverage offloading devices (such as DSA/IOAT). While applications or libraries 210 can directly access the DSA 220 or IOAT 230 public low-level libraries (e.g., via instructions idxd_batch_create( )/idxd_submit_copy( ) or ioat_submit_fill( )/ioat_submit_copy( ), respectively), they can also use the proposed acceleration framework 240, which may comprise one or more of a DSA module 242, and IOAT module 244, a software module 246 and other module(s) 248. Regardless of which offloading engine is used, the framework may be accessed by the same instructions, such as accel_batch_submit( ), accel_batch_cancel( ), accel_submit_copy( ), accel_submit_fill( ), accel_submit_crc32c( ), accel_batch_prep_fill( ), or accel_check_completion( ).

For example, two issues may be addressed by using an offloading device (such as DSA/IOAT) to operate on PMEM memory. In some cases, the capability of some offloading devices might not be powerful enough. For example, the bandwidth of single DSA bandwidth on SPR is 30 GB/s. If the offload operations between memory and persistent memory are performed in a synchronous manner, the performance benefit with DSA might be less than ideal. So, a properly designed asynchronized framework may be used to offload operations between memory and PMES. For example, the framework may be in a scalable way, to other memory offloading devices can be added in the future.

In some examples, the CPU may use CLFLUSH or CLWB instructions to persistent data on the persistent memory. The support for such operations may be available in the aforementioned PMDK library or others. If a memory offloading device is used, the offloading device may be used such that these operations are supported as well.

As shown in FIG. 2, users (e.g., application developers) do not need to directly deal with the low-level DSA/IOAT libraries 220; 230. The acceleration framework 240 may provide the public APIs listed above (e.g., accel_submit_*). Inside the acceleration framework, the three different modules, i.e., IOAT module 244, DSA module 242 and software module 246, may be encapsulated. Other modules, such as next-generation IA platforms, can also be added if there are new types of (offloading) devices. For example, each module, may be linked to a corresponding low-level library. For example, the DSA module 242 may rely on the DSA low level library 220, and the IOAT module 244 may rely on the IOAT low level library 230. The public APIs for directly using each device (e.g., idxd_submit_copy( ) for using the functionality provided by DSA device) may still be provided (while not being recommended).

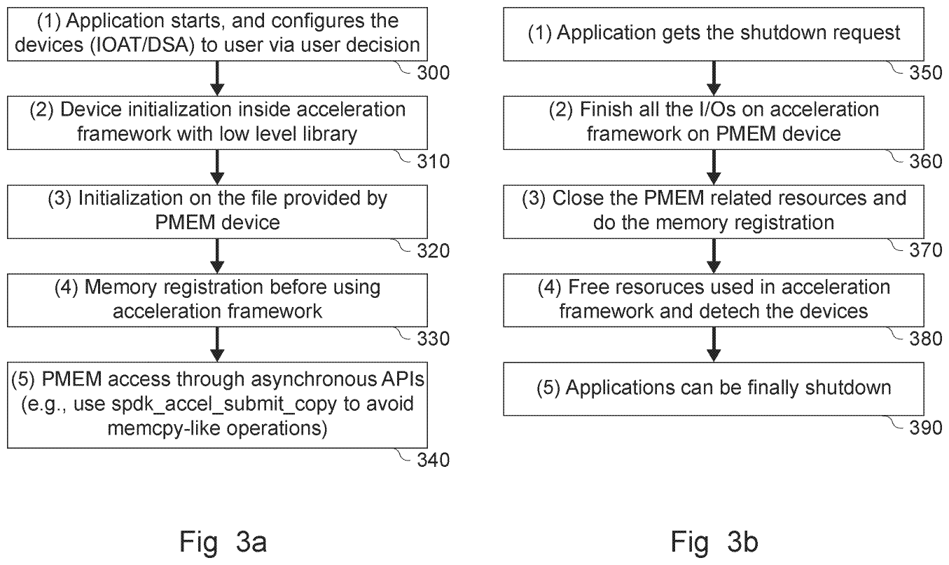

In various examples, the acceleration framework may be used to accelerate the PMEM access, e.g., for storage use cases, while guaranteeing data integrity in some unexpected cases (e.g., when power is lost). FIGS. 3a and 3b show flow charts of a usage of the proposed acceleration framework with the PMEM device. In FIG. 3a, it is shown how an application initializes the acceleration framework and how the acceleration with the asynchronous API is used. For example, the flow chart may comprise one or more of the following stages: (1) Application starts, and configures the devices (IOAT/DSA) to user via user decision (300), (2) Device initialization inside acceleration framework with low-level library (310), (3) Initialization on the file provided by the PMEM device (320), (4) Memory registration before using acceleration framework (330), and (5) PMEM access through asynchronous APIs (e.g., use accel_submit_copy to avoid memcpy-like operations) (340).

In FIG. 3b, it is shown how to recycle the resources related with the acceleration framework while stopping the application (while the application destructs the use of the acceleration framework). For example, the flow chart may comprise one or more of the following stages: (1) Application gets the shutdown request (350), (2) Finish all the I/Os on the acceleration framework on the PMEM device (360), (3) Close the PMEM-related resources and to the memory (de-)registration (370), (4) Free resources used in acceleration framework and detach the devices (380), and (5) Applications can be finally shutdown (390).

In general, offloading devices such as IOAT/DSA are designed to accelerate the usage of networking, PMEM or memory. However, in particular with respect to PMEM or memory, little practical knowledge may exist with respect to their use. In the following, some examples with respect to a use of offloading devices, such as IOAT/DSA, with memory and PMEM, are shown.

In the following, the access of the offloading device on the PMEM device is discussed. In general, PMEM devices can be formatted with different block sizes, alignment values (e.g., 2 MB size). While using an offloading device, one or more of the following aspects may be considered. For example, PMEM address regions may be pinned to process virtual memory (e.g., huge pages), e.g., to make sure the PMEM device address can be mapped to the process without changing at runtime (e.g., task (4) (330) of FIG. 3a, task (3) (370) of FIG. 3b). For example, a technology like IOMMU (I/O Memory Management Unit) may be used. From the software side, a PMEM memory registration/un-registration function may be provided, so the offloading devices can know the registered regions. The registration function may provide a memory management function, so the memory region of persistent memory can be recognized by IOAT/DSA with page granularity (e.g., 4 KB, or 2 MB), e.g., Memory translation functions may be implemented under IOMMU by ensuring that the PMEM memory can be accessed by the underlying device. Then, the offloading device may always access the PMEM based memory. The PMEM device may be correctly mapped into the process's memory space to enable userspace offloading device usage. In addition, the alignment while using the offloading device to access the PMEM may be enforced. During the design and usage, the proposed concept may (always) let the offloading device access the PMEM according to the alignment, e.g., 2 MB granularity or others. If the address is not aligned, some conversions may be performed, or the access request may be split.

To illustrate the above two aspects in more detail, the following techniques may be used in the Linux OS (as an example) to achieve this. However, similar techniques can also be used in other modern operating systems (e.g., Microsoft Windows). For example, if a PMEM region is to be mapped from a PMEM device from offset X with size S, alignment page_size (of the offloading device) PAGE_SIZE_A (e.g., 2 MB), the following process may be used. (1) Use a system call to open the PMEM device (/dev/dax1.0) and get a FD (File Descriptor) and use a series of operations to determine the total size of the PMEM device. (2) Use the mmap (Memory Map) for operations. For example, it may be mapped into anonymous memory, e.g., using p_return_addr=mmap(NULL, allocated_size, PROT_READ|PROT_WRITE, MAP_PRIVATE|MAP_ANONYMOUS, −1,0); Here, the allocated_size should not be S, as the returned address (p_return_addr) might not be aligned. For example, allocated_size may be set as allocated_size=S+PAGE_SIZE_A. In effect, a 2 MB aligned address may be obtained later. (3) Then, munmap(p_return_addr, allocated_size) may be called, and p_real_addr may be set to p_real_addr=(p_return_addr+PAGE_SIZE_A−1) &˜(PAGE_SIZE_A−1). (4) Them, mmap may be called again: mmap(p_real_addr, S, PROT_READ|PROT_WRITE, MAP_SHARED|MAP_FIXED, FD, X). In (4), the contents from the persistent device from offset X with size=S may be mapped on p_real_addr (with MAP_FIXED macro). Tasks (2) to (4) may be protected by locks or just executed by a single thread. In effect, the contents on PMEM device may be mapped to a fixed and aligned address for the offloading device to access, without the contents being swapped out. In particular, (2) maps an anonymous virtual address range with a related bigger size than expected. (3) obtains an aligned address from the address obtained in (2). Then (4) maps the region of the PMEM device in the aligned address with specified address, which can be used to satisfy the alignment requirements for the offloading device to access and also can be pinned in the memory.

Various examples of the present disclosure may provide asynchronous API usage. As shown in FIG. 2, the common APIs may be provided while using the underlying devices (such as IOAT or DSA) in the acceleration framework. The APIs provided may be designed to support asynchronous operations. This means that while the users use those APIs, the result might not be immediately returned, but will be returned by the call back function notification after the devices have been queried. Various examples of the proposed concept use this asynchronous concept. It may save CPU resources and avoid the unnecessary busy waiting time by the CPU. This asynchronous API handling is useful, because the offloading capability of many memory offloading devices is slightly better than the CPU. If a synchronous API is used, CPU resources might not be saved, as the CPU might still wait for the results from the device. So, the asynchronous API may be used to address this, saving CPU resources and avoiding the unnecessary CPU busy waiting cycle.

In the following, a concrete example is given with respect to copying from memory address src to dst (which is a PMEM region) with size lens. The example is given to demonstrate the difference between CPU and IOAT/DSA. When the CPU is used, the command pmem_memcpy_persist(dst, src, len) may be used, which is a synchronous operation. When an offloading device, such as IOAT or DSA is used, the following commands may be used: (1) accel_submit_copy( . . . , dst, src, len, flags, cb_fn, cb_args), which is an asynchronous operation, with flags setting for persistency usage. A new task may be created internally to store the asynchronous I/O information. (2) accel_check_completion( ), to check whether the task is completed. If the submitted tasks are completed, then cb_fn (a callback function) with cb_args (callback arguments) will be called and notify the upper layer. This check might not be called after performing (1). It may be done by a backend lightweight thread or by the same thread in another CPU slot. For example, this example may illustrate task (5) 340 of FIG. 3a. In the example, the CPU uses a synchronous operation to copy memory contents to persistent memory. To make sure the data is still valid while power is off, then we can use some functions provided by PMDK library, e.g., pmem_memcpy_persist. When using an offloading device with the proposed acceleration framework, synchronous operations might be avoided.

In the example, the copy operation, as performed using the offloading device, is divided into two different tasks. In (1), accel_submit_copy is called. The flags shown in this function can be used to guide the different level drivers to make the data persistent if the destination address is in a persistent memory region. This may be supported in different device implementations by the respective offloading device. In (2), this statement might not be called immediately in the same CPU context, it can be called by the backend threads or called by the same thread in the proper CPU time slot. For example, in PMEM device operation, the CPU may be used directly to do memory copy between memory and the PMEM device. If the direct operation is replaced with the accel_submit_copy API, then after the submission, the CPU will not wait, and the CPU can do other tasks. In some examples, the framework may use a dedicated function to check the devices, the polling usage. For example, asynchronous API calls and polling may be used, which may improve the performance while accessing the PMEM device and reduces the CPU burden.

Usually, an asynchronous API can be used in a single thread model, e.g., as shown in the following:

```
While (1) {
  statement 1;
  if (need_offload) { accel_submit_copy( );}
  statement 2;
  accel_check_completion( );
  statement 3;
  if(need_exit_loop) {
    break;
  }
}
```

In single thread mode, the user creates a dedicated thread to do all kinds of work in a while loop with many different tasks. As can be seen from the program listing, (1) and (2) can be completed without waiting for the results conducted by (1) in the same while loop. Instead, the operation may be completed in a different while loop. This strategy may combine the async with polling usage, which may be more efficient than the synchronous operation.

In the following, a short overview of performance reached by an example implementation. The acceleration framework was evaluated on different computer systems with IOAT/DSA devices and PMEM devices (Intel® Optane™ 1^{st} and 3^{rd} generation (named AEP, CPS)). Three different combinations were tested: Acceleration framework+IOAT+AEP, acceleration framework+IOAT+BPS, and acceleration framework+IOAT+CPS.

Under 2 different usage cases, the proposed concept worked well and showed improved performance. The PMEM device was formatted in DAX mode, and the device (e.g., /dev/dax1.0) could be directly used in order to bypass the CPU cache. A block device was created in the SPDK application based upon the given PMEM base char device. The use of a block device means that the application operates the device with LBA (logical block address) granularity under the predefined block size (e.g., 4096). Some workloads were generated with applications using the proposed acceleration framework. The performance between purely CPU usage and usage of the IOAT/DSA device under the acceleration framework was compared. According to the results, when the IOAT/DSA device was used, more than 1.5× performance improvement on IOPS were reached. During the test, the bdevperf tool provided in the SPDK project was used, which is a similar tool like FIO and can be used to demonstrate the performance on a SDPK bdev (block device) created on a persistent memory device (e.g., /dev/dax1.0 via CPU or IOAT/DSA).

In a first test, bdevperf (with an I/O pool size of 65535 and a I/O cache size of 256, a DAX device with 262144 blocks of block size 4096) was used with an IOAT device (present) and AEP/BPS PMEM. In a first run, the IOAT device was used to access an AEP PMEM device, resulting in 1618626.00 IOPS and 6322.76 MiB/s. When the CPU was used directly to perform the operations (without IOAT), 867448.00 IOPS and 3388.47 MiB/s were reached. The performance improvement on IOPS is about: 6322.76/3388.47=1.86.

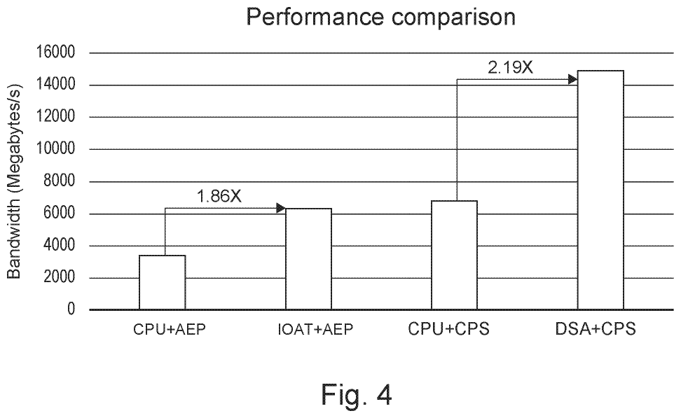

In a second test, a computer system with a DSA device and a CPS PMEM device was used to run bdevperf (with an I/O pool size of 65535 and a I/O cache size of 256, a DAX device with 262144 blocks of block size 4096). When the DSA device was used, 3812464.90 IOPS and 14892.44 MiB/s were reached. When the CPU was used directly to perform the operations (without DSA), 1737763.20 IOPS and 6788.14 MiB/s were reached. In this case, the performance improvement on IOPS is about 14892.44/6788.14=2.19. FIG. 4 shows a chart, comparing the performance of different combinations of CPU+AEP (first generation Intel® Optane PMEM), IOAT+AEP, CPU+CPS (third generation Intel® Optane PMEM) and DSA+CPS.

Generally, the performance improvement may be based on the capability of the offloading devices under the acceleration framework as the devices take over the copy job between memory and PMEM device and thus reduce the CPU burden. Consequently, the CPU may issue more read/write I/O requests to the PMEM device. Another reason is the asynchronous nature of the APIs provided by the acceleration framework, thus the CPU does not need to wait for the response from the underlying device directly, which also saves the CPU resources.

Persistent memory in app direct mode can also be formatted with block devices (e.g., /dev/pmem0), so users can create the file systems upon this device. However, offloading devices might not be able to directly access the PMEM memory while users specify “−o DAX” to mount the PMEM devices, which may require kernel support. Therefore, in some examples of the proposed framework, PMEM devices formatted as char devices were used. Improved performance was obtained as well of the possibility of bypassing the CPU cache (to deal with potential power loss), while providing the same features that ware also available to the CPU directly.

In the proposed concept, a unified and lightweight framework is provided to leverage memory offloading devices such as IOAT/DSA to accelerate the PMEM device. Compared with other frameworks, the proposed framework is more lightweight and especially easy to be integrated for storage acceleration cases. Offloading devices, such as IOAT and DSA, were used to improve the performance or reduce the CPU utilization while accessing PMEM devices. In various examples, this is enabled by the use of the lightweight framework and the use of asynchronous APIs, which may explore the full benefit of using an offloading device. For example, the asynchronous interface may be used to support useful functionality, such as batching, QoS etc.

Thus, the CPU bottleneck while operating on PMEM devices with high workloads is addressed by the proposed concept. Compared with doing I/Os on PCIe SSDs or other HDDs, there is DMA (direct memory access) features inside those devices, and CPUs will not become a bottleneck, since CPUs will not need to complete those I/Os by themselves. However, with PMEM device, there is no such feature. The proposed concept provides memory offloading devices to address this issue. To make it general and applicable to many usage cases, we a light weighted framework is introduced. For example, the framework may leverage different memory offloading devices (e.g., IOAT/DSA) targeting for different generation persistent memory devices (e.g., AEP/BPS/CPS). Moreover, other or new memory offloading devices may be integrated in the framework via the interface.

More details and aspects of the method and apparatus for accelerating persistent memory access and/or ensuring the data integrity via a hardware-based memory offloading technique are mentioned in connection with the proposed concept or one or more examples described above or below (e.g., FIG. 1a to 1c). The method and apparatus for accelerating persistent memory access and/or ensuring the data integrity via a hardware-based memory offloading technique may comprise one or more additional optional features corresponding to one or more aspects of the proposed concept, or one or more examples described above or below.

In the following, some examples are presented:

An example (e.g., example 1) relates to an apparatus (10) for a computer system (100), the apparatus comprising circuitry (12; 14; 16) configured to provide an interface for accessing persistent memory provided by persistent memory circuitry (102) of the computer system from one or more software applications (106). The circuitry is configured to translate instructions for performing operations on the persistent memory into corresponding instructions for offloading circuitry (104) of the computer system, the corresponding instructions being suitable for instructing the offloading circuitry to perform the operations on the persistent memory. The circuitry is configured to provide the access to the persistent memory via the offloading circuitry.

Another example (e.g., example 2) relates to a previously described example (e.g., example 1) or to any of the examples described herein, further comprising that the circuitry is configured to expose the access to the persistent memory as a virtual block-level device or a byte-addressable device.

Another example (e.g., example 3) relates to a previously described example (e.g., example 1) or to any of the examples described herein, further comprising that the circuitry is configured to provide the access to the persistent memory via asynchronous interface calls.

Another example (e.g., example 4) relates to a previously described example (e.g., example 3) or to any of the examples described herein, further comprising that the circuitry is configured to translate the instructions for performing operations on the persistent memory into corresponding asynchronous instructions for the offloading circuitry.

Another example (e.g., example 5) relates to a previously described example (e.g., example 4) or to any of the examples described herein, further comprising that the circuitry is configured to translate callback notifications issued by the offloading circuitry into callback notifications for the one or more software applications.

Another example (e.g., example 6) relates to a previously described example (e.g., one of the examples 1 to 5) or to any of the examples described herein, further comprising that the circuitry is configured to perform memory management for accessing the persistent memory.

Another example (e.g., example 7) relates to a previously described example (e.g., example 6) or to any of the examples described herein, further comprising that the circuitry is configured to provide access to the persistent memory via a memory mapping technique, with the memory management mapping the persistent memory address space to virtual memory addresses.

Another example (e.g., example 8) relates to a previously described example (e.g., example 7) or to any of the examples described herein, further comprising that the circuitry is configured to map the persistent memory to the virtual memory addresses using a pinned page mechanism.

Another example (e.g., example 9) relates to a previously described example (e.g., one of the examples 7 to 8) or to any of the examples described herein, further comprising that the circuitry is configured to perform virtual memory registration, by setting up the virtual memory addresses and mapping the virtual memory addresses to addresses of the persistent memory address space.

Another example (e.g., example 10) relates to a previously described example (e.g., one of the examples 7 to 9) or to any of the examples described herein, further comprising that the circuitry is configured to initialize a portion of the persistent memory address space with an alignment of memory addresses that matches the offloading circuitry access alignment requirements.

Another example (e.g., example 11) relates to a previously described example (e.g., example 10) or to any of the examples described herein, further comprising that alignment of memory addresses is based on multiples of the corresponding memory page sizes.

Another example (e.g., example 12) relates to a previously described example (e.g., one of the examples 1 to 11) or to any of the examples described herein, further comprising that the circuitry is configured to provide the corresponding instructions to the offloading circuitry via a low-level library of the offloading circuitry.

Another example (e.g., example 13) relates to a previously described example (e.g., example 12) or to any of the examples described herein, further comprising that the circuitry is configured to provide access to the persistent memory via first offloading circuitry and via second offloading circuitry, and to select the low-level library of the first or second offloading circuitry depending on which of the first and second offloading circuitry is used for accessing the persistent memory.

Another example (e.g., example 14) relates to a previously described example (e.g., one of the examples 1 to 13) or to any of the examples described herein, further comprising that the circuitry is configured to provide the interface and/or translate the instructions by providing a software framework for accessing the persistent memory.

An example (e.g., example 15) relates to a computer system (100) comprising the apparatus (10) according to one of the examples 1 to 14 or according to any other example, the offloading circuitry (104) and the persistent memory circuitry (102).

Another example (e.g., example 16) relates to a previously described example (e.g., example 15) or to any of the examples described herein, further comprising that the offloading circuitry is included in a central processing unit of the computer system.

Another example (e.g., example 17) relates to a previously described example (e.g., one of the examples 15 to 16) or to any of the examples described herein, further comprising that the offloading circuitry is one of computation offloading circuitry and data access offloading circuitry.

An example (e.g., example 18) relates to a device (10) for a computer system (100), the device comprising means (12; 14; 16) configured to provide an interface for accessing persistent memory provided by persistent memory device (102) of the computer system from one or more software applications. The means is configured to translate instructions for performing operations on the persistent memory into corresponding instructions for means for offloading (104) of the computer system, the corresponding instructions being suitable for instructing the means for offloading to perform the operations on the persistent memory. The means is configured to provide the access to the persistent memory via the means for offloading.

Another example (e.g., example 19) relates to a previously described example (e.g., example 18) or to any of the examples described herein, further comprising that the means for processing is configured to expose the access to the persistent memory as a virtual block-level device or a byte-addressable device.

Another example (e.g., example 20) relates to a previously described example (e.g., example 18) or to any of the examples described herein, further comprising that the means for processing is configured to provide the access to the persistent memory via asynchronous interface calls.

Another example (e.g., example 21) relates to a previously described example (e.g., example 20) or to any of the examples described herein, further comprising that the means for processing is configured to translate the instructions for performing operations on the persistent memory into corresponding asynchronous instructions for the means for offloading.

Another example (e.g., example 22) relates to a previously described example (e.g., example 21) or to any of the examples described herein, further comprising that the means for processing is configured to translate callback notifications issued by the means for offloading into callback notifications for the one or more software applications.

Another example (e.g., example 23) relates to a previously described example (e.g., one of the examples 18 to 22) or to any of the examples described herein, further comprising that the means for processing is configured to perform memory management for accessing the persistent memory.

Another example (e.g., example 24) relates to a previously described example (e.g., example 23) or to any of the examples described herein, further comprising that the means for processing is configured to provide access to the persistent memory via a memory mapping technique, with the memory management mapping the persistent memory address space to virtual memory addresses.

Another example (e.g., example 25) relates to a previously described example (e.g., example 24) or to any of the examples described herein, further comprising that the means for processing is configured to map the persistent memory to the virtual memory addresses using a pinned page mechanism.

Another example (e.g., example 26) relates to a previously described example (e.g., one of the examples 24 to 25) or to any of the examples described herein, further comprising that the means for processing is configured to perform virtual memory registration, by setting up the virtual memory addresses and mapping the virtual memory addresses to addresses of the persistent memory address space.

Another example (e.g., example 27) relates to a previously described example (e.g., one of the examples 24 to 26) or to any of the examples described herein, further comprising that the means for processing is configured to initialize a portion of the persistent memory address space with an alignment of memory addresses that matches the means for offloading access alignment requirements.

Another example (e.g., example 28) relates to a previously described example (e.g., example 27) or to any of the examples described herein, further comprising that alignment of memory addresses is based on multiples of the corresponding memory page sizes.

Another example (e.g., example 29) relates to a previously described example (e.g., one of the examples 18 to 28) or to any of the examples described herein, further comprising that the means for processing is configured to provide the corresponding instructions to the means for offloading via a low-level library of the means for offloading.

Another example (e.g., example 30) relates to a previously described example (e.g., example 29) or to any of the examples described herein, further comprising that the means for processing is configured to provide access to the persistent memory via first means for offloading and via second means for offloading, and to select the low-level library of the first or second means for offloading depending on which of the first and second means for offloading is used for accessing the persistent memory.

Another example (e.g., example 31) relates to a previously described example (e.g., one of the examples 18 to 30) or to any of the examples described herein, further comprising that the means for processing is configured to provide the interface and/or translate the instructions by providing a software framework for accessing the persistent memory.

An example (e.g., example 32) relates to a computer system (100) comprising the device (10) according to one of the examples 18 to 33 or according to any other example, the means for offloading (104) and the persistent memory device (102).

Another example (e.g., example 33) relates to a previously described example (e.g., example 32) or to any of the examples described herein, further comprising that the means for offloading is included in a central processing unit of the computer system.

Another example (e.g., example 34) relates to a previously described example (e.g., one of the examples 32 to 33) or to any of the examples described herein, further comprising that the means for offloading is one of computation means for offloading, data access means for offloading and input/output access means for offloading.

An example (e.g., example 35) relates to a method for a computer system (100), the method comprising providing (110) an interface for accessing persistent memory provided by persistent memory circuitry (102) of the computer system from one or more software applications. The method comprises translating (130) instructions for performing operations on the persistent memory into corresponding instructions for offloading circuitry (104) of the computer system, the corresponding instructions being suitable for instructing the offloading circuitry to perform the operations on the persistent memory. The method comprises providing (150) the access to the persistent memory via the offloading circuitry.

Another example (e.g., example 36) relates to a previously described example (e.g., example 35) or to any of the examples described herein, further comprising that the method comprises exposing (155) the access to the persistent memory as a virtual block-level device or a byte-addressable device.

Another example (e.g., example 37) relates to a previously described example (e.g., example 35) or to any of the examples described herein, further comprising that the access to the persistent memory is provided (150) via asynchronous interface calls.

Another example (e.g., example 38) relates to a previously described example (e.g., example 37) or to any of the examples described herein, further comprising that the instructions for performing operations on the persistent memory are translated (130) into corresponding asynchronous instructions for the offloading circuitry.

Another example (e.g., example 39) relates to a previously described example (e.g., example 38) or to any of the examples described herein, further comprising that the method comprises translating (135) callback notifications issued by the offloading circuitry into callback notifications for the one or more software applications.

Another example (e.g., example 40) relates to a previously described example (e.g., one of the examples 35 to 39) or to any of the examples described herein, further comprising that the method comprises performing (120) memory management for accessing the persistent memory.

Another example (e.g., example 41) relates to a previously described example (e.g., example 40) or to any of the examples described herein, further comprising that access to the persistent memory is provided (150) via a memory mapping technique, with the memory management mapping (126) the persistent memory address space to virtual memory addresses.

Another example (e.g., example 42) relates to a previously described example (e.g., example 41) or to any of the examples described herein, further comprising that the method comprises mapping (126) the persistent memory to the virtual memory addresses using a pinned page mechanism.

Another example (e.g., example 43) relates to a previously described example (e.g., one of the examples 41 to 42) or to any of the examples described herein, further comprising that the method comprises performing (122) virtual memory registration, by setting up the virtual memory addresses and mapping the virtual memory addresses to addresses of the persistent memory address space.

Another example (e.g., example 44) relates to a previously described example (e.g., one of the examples 41 to 43) or to any of the examples described herein, further comprising that the method comprises initializing (124) a portion of the persistent memory address space with an alignment of memory addresses that matches the offloading circuitry access alignment requirements.

Another example (e.g., example 45) relates to a previously described example (e.g., example 44) or to any of the examples described herein, further comprising that alignment of memory addresses is based on multiple of the corresponding memory page sizes.

Another example (e.g., example 46) relates to a previously described example (e.g., one of the examples 35 to 45) or to any of the examples described herein, further comprising that the method comprises providing (140) the corresponding instructions to the offloading circuitry via a low-level library of the offloading circuitry.

Another example (e.g., example 47) relates to a previously described example (e.g., example 46) or to any of the examples described herein, further comprising that the method comprises providing (150) access to the persistent memory via first offloading circuitry and via second offloading circuitry and selecting (145) the low-level library of the first or second offloading circuitry depending on which of the first and second offloading circuitry is used for accessing the persistent memory.

Another example (e.g., example 48) relates to a previously described example (e.g., one of the examples 35 to 47) or to any of the examples described herein, further comprising that the interface is provided and/or the instructions are translated by a software framework for accessing the persistent memory.

An example (e.g., example 49) relates to a computer system (100) comprising the offloading circuitry (104) and the persistent memory circuitry (102), the computer system being configured to perform the method of one of the examples 35 to 48 or according to any other example.

Another example (e.g., example 50) relates to a previously described example (e.g., example 49) or to any of the examples described herein, further comprising that the offloading circuitry is included in a central processing unit of the computer system.

Another example (e.g., example 51) relates to a previously described example (e.g., one of the examples 49 to 50) or to any of the examples described herein, further comprising that the offloading circuitry is one of computation offloading circuitry and data access offloading circuitry.

An example (e.g., example 52) relates to a non-transitory machine-readable storage medium including program code, when executed, to cause a machine to perform the method of one of the examples 35 to 48.

An example (e.g., example 53) relates to a computer program having a program code for performing the method of one of the examples 35 to 48 when the computer program is executed on a computer, a processor, or a programmable hardware component.

An example (e.g., example 54) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for a computer system, the apparatus comprising circuitry configured to:
provide an interface for accessing persistent memory provided by persistent memory circuitry of the computer system from one or more software applications;
translate instructions for performing operations on the persistent memory into corresponding instructions for offloading circuitry of the computer system, the corresponding instructions being suitable for instructing the offloading circuitry to perform the operations on the persistent memory; and
provide the access to the persistent memory via the offloading circuitry.

2. The apparatus according to claim 1, wherein the circuitry is configured to expose the access to the persistent memory as a virtual block-level device or a byte-addressable device.

3. The apparatus according to claim 1, wherein the circuitry is configured to provide the access to the persistent memory via asynchronous interface calls.

4. The apparatus according to claim 3, wherein the circuitry is configured to translate the instructions for performing operations on the persistent memory into corresponding asynchronous instructions for the offloading circuitry.

5. The apparatus according to claim 4, wherein the circuitry is configured to translate callback notifications issued by the offloading circuitry into callback notifications for the one or more software applications.

6. The apparatus according to claim 1, wherein the circuitry is configured to perform memory management for accessing the persistent memory.

7. The apparatus according to claim 6, wherein the circuitry is configured to provide access to the persistent memory via a memory mapping technique, with the memory management mapping the persistent memory address space to virtual memory addresses.

8. The apparatus according to claim 7, wherein the circuitry is configured to map the persistent memory to the virtual memory addresses using a pinned page mechanism.

9. The apparatus according to claim 7, wherein the circuitry is configured to perform virtual memory registration, by setting up the virtual memory addresses and mapping the virtual memory addresses to addresses of the persistent memory address space.

10. The apparatus according to claim 7, wherein the circuitry is configured to initialize a portion of the persistent memory address space with an alignment of memory addresses that matches the offloading circuitry access alignment requirements.

11. The apparatus according to claim 10, wherein alignment of memory addresses is based on multiples of the corresponding memory page sizes.

12. The apparatus according to claim 1, wherein the circuitry is configured to provide the corresponding instructions to the offloading circuitry via a low-level library of the offloading circuitry.

13. The apparatus according to claim 12, wherein the circuitry is configured to provide access to the persistent memory via first offloading circuitry and via second offloading circuitry, and to select the low-level library of the first or second offloading circuitry depending on which of the first and second offloading circuitry is used for accessing the persistent memory.

14. The apparatus according to claim 1, wherein the circuitry is configured to provide the interface and/or translate the instructions by providing a software framework for accessing the persistent memory.

15. (canceled)

16. (canceled)

17. (canceled)

18. A device for a computer system, the device comprising means configured to:
provide an interface for accessing persistent memory provided by persistent memory device of the computer system from one or more software applications;
translate instructions for performing operations on the persistent memory into corresponding instructions for means for offloading of the computer system, the corresponding instructions being suitable for instructing the means for offloading to perform the operations on the persistent memory; and
provide the access to the persistent memory via the means for offloading.

19. (canceled)

20. A method for a computer system, the method comprising:
providing an interface for accessing persistent memory provided by persistent memory circuitry of the computer system from one or more software applications;
translating instructions for performing operations on the persistent memory into corresponding instructions for offloading circuitry of the computer system, the corresponding instructions being suitable for instructing the offloading circuitry to perform the operations on the persistent memory; and
providing the access to the persistent memory via the offloading circuitry.

21. A non-transitory, machine-readable storage medium including a program code for performing the method of claim 20 when the program code is executed on a computer, a processor, or a programmable hardware component.

22. The method according to claim 20, further comprising exposing the access to the persistent memory as a virtual block-level device or a byte-addressable device.

23. The method according to claim 20, further comprising that the access to the persistent memory is provided via asynchronous interface calls.

24. The method according to claim 20, further comprising that the instructions for performing operations on the persistent memory are translated into corresponding asynchronous instructions for the offloading circuitry.
